(19) United States
(12) Patent Application Publication
(10) Pub. No.: US 2024/0373852 A1
(43) Pub. Date: Nov. 14, 2024

(54) COMPOSITION FOR ALLEVIATING DROUGHT STRESS COMPRISING AMINO ACID

(71) Applicant: CJ CheilJedang Corporation, Seoul (KR)

(72) Inventors: Youngjoo OH, Seoul (KR); Ju Yeon SON, Seoul (KR); Gyuree KIM, Seoul (KR); Yuna KANG, Seoul (KR)

(73) Assignee: CJ CheilJedang Corporation, Seoul (KR)

(21) Appl. No.: 18/690,259

(22) PCT Filed: Aug. 5, 2022
(86) PCT No.: PCT/KR2022/011689

§ 371 Date: Mar. 7, 2024

(30) Foreign Application Priority Data
Feb. 9, 2022 (KR) 10-2022-0017110

(51) Int. Cl. A01N 43/56; A01G 7/06; A01N 37/44; A01N 43/38; A01P 21/00

(52) U.S. Cl. CPC A01N 43/56; A01G 7/06; A01N 37/44; A01N 43/38; A01P 21/00

(57) ABSTRACT

The present application relates to a use for alleviating drought stress of an amino acid, and the amino acids can achieve an excellent effect of alleviating drought stress or promoting plant growth.

The present application claims the benefit of the priority based on Korean Patent Application No. 10-2022-0017110 filed on Feb. 9, 2022, and the entire contents disclosed in the document of the corresponding Korean patent application are incorporated as a part of the present description.

### CROSS-REFERENCE TO RELATED APPLICATION(S)

The present application relates to a use of an amino acid having efficacy of alleviating drought stress.

### TECHNICAL FIELD

### Background Art

Water is an essential element necessary for growth and development of-plants, and a large amount of water is continuously required throughout the entire growth and development of plants. In growth and development of plants, water supply greatly affects processes of photosynthesis, respiration, nutrient absorption and transport and the like, and this is closely related to plant productivity.

However, due to recent climate change, plants are exposed to various unpredictable environmental stresses, and therefore, there is a problem of decreasing plant productivity caused thereby, and in particular, the plant yield is greatly reduced because of water shortage, drought, and the like, due to abnormal climate. Even excluding climate change, a water shortage phenomenon is increasing all over the world, and the way to reduce water consumption for plant production is getting important.

Amino acids are essential for plant growth and development, and have recently been attracting attention as one of main materials which can be used as biostimulant for growth promotion that could replace chemical fertilizers. Additionally, amino acids having efficacy of alleviating drought stress which enables normal growth and development of plants under drought stress (insufficient water condition) and overcoming a decrease in production have been newly selected.

### PRIOR ART

### Patent Document

(Patent document 1) US 2018-0206498 A1

### DISCLOSURE

### Technical Problem

An object of the present application is to provide a composition for alleviating drought stress comprising amino acids as an active ingredient.

Another object of the present application is to provide a composition for promoting plant growth comprising amino acids as an active ingredient.

Other object of the present application is to provide a fertilizer composition comprising amino acids.

Other object of the present application is to provide a method for cultivating a plant, or a method for alleviating drought stress of a plant, comprising a step of treating amino acids to plants.

Other object of the present application is to provide a use of the amino acids for using in alleviating drought stress.

Other object of the present application is to provide a use of the amino acids for using in promoting plant growth.

Other object of the present application is to provide a use of the amino acids for using in preparation of the composition for alleviating drought stress.

Other object of the present application is to provide a use of the amino acids for using in preparation of the composition for promoting plant growth.

### Technical Solution

This will be described in detail as follows. Each description and embodiment disclosed in the present application may be applied to each other description and embodiment. In other words, all combinations of various elements disclosed in the present application fall within the scope of the present application. In addition, it cannot be seen that the scope of the present application is limited by the detailed description described below. Furthermore, those skilled in the art can recognize or confirm many equivalents to specific aspects of the present application described in the present application using only a common experiment. In addition, these equivalents are intended to be included in the present application.

Hereinafter, the present application will be described in more detail.

### Amino Acids

The amino acids provided in the present application may be at least one (for example, one or more kinds, 2 or more kinds, 3 or more kinds, 4 or more kinds, 5 or more kinds, 6 or more kinds, 7 or more kinds, 8 or more kinds, 9 or more kinds, 10 or more kinds, 11 or more kinds, 12 or more kinds, 13 or more kinds, 14 or more kinds, 15 or more kinds, 16 or more kinds, 17 or more kinds, 18 or more kinds, or 19 or more kinds, or, 1 kind, 2 kinds, 3 kinds, 4 kinds, 5 kinds, 6 kinds, 7 kinds, 8 kinds, 9 kinds, 10 kinds, 11 kinds, 12 kinds, 13 kinds, 14 kinds, 15 kinds, 16 kinds, 17 kinds, 18 kinds, 19 kinds, or 20 kinds) amino acid selected from the group consisting of arginine (Arg), histidine (His), lysine (Lys), aspartic acid (Asp), glutamic acid (Glu), serine(S), threonine (Thr), asparagine (Asp), glutamine (Gln), cysteine (Cys), glycine (Gly), proline (Pro), alanine (Ala), valine (Val), isoleucine (Ile), leucine (Leu), methionine (Met), phenylalanine (Phe), tyrosine (Tyr), and tryptophan (Trp) or a salt thereof.

In the present description, when the term “amino acid” is used alone, this may be used as meaning both an amino acid or a salt of the amino acid. In addition, the amino acid or salt thereof may be described as “amino acids”.

In one embodiment, the salt of histidine may be hydrochloride of histidine (His-HCl), and the salt of glutamic acid may be a sodium salt of glutamic acid (sodium glutamate, MSG, monosodium glutamate), and the salt of lysine may be hydrochloride of lysine (Lys-HCl).

Herein, a salt of an amino acid may mean a physiologically acceptable salt among salts which are substances in which a cation and an anion are combined by electrostatic attraction, and for example, may mean an agrochemically acceptable salt and/or a salt applicable for plant cultivation. For example, the salt may be at least one selected from the group consisting of metal salts, salts with organic bases, salts with inorganic bases, salts with organic acids and the like. In one embodiment, the metal salt may be at least one selected from the group consisting of alkali metal salts (sodium salt, potassium salt, etc.), alkali earth metal salts (calcium salt, magnesium salt, barium salt, etc.), aluminum salts and the like; and the salt with organic bases may be at least one selected from the group consisting of salts with triethylamine, pyridine, picoline, 2,6-lutidine, ethanolamine, diethanolamine, triethanolamine, cyclohexylamine, dicyclohexylamine, N,N-dibenzylethylenediamine, and the like; and the salts with inorganic acids may be at least one selected from the group consisting of hydrochloric acid, hydrobromic acid, nitric acid, sulfuric acid, phosphoric acid and the like; and the salt with organic acids may be at least one selected from the group consisting of salts with formic acid, acetic acid, trifluoroacetic acid, phthalic acid, fumaric acid, oxalic acid, tartaric acid, maleic acid, citric acid, succinic acid, methane sulfonic acid, benzene sulfonic acid, p-toluene sulfonic acid, and the like.

In one embodiment, the amino acid or salt thereof may be,
at least one (for example, one or more kinds, 2 or more kinds, 3 or more kinds, 4 or more kinds, 5 or more kinds, 6 or more kinds, 7 or more kinds, 8 or more kinds, 9 or more kinds, or 1 kind, 2 kinds, 3 kinds, 4 kinds, 5 kinds, 6 kinds, 7 kinds, 8 kinds, 9 kinds, or all of 10 kinds) amino acid selected from the group consisting of tryptophan, glutamic acid, histidine, alanine, arginine, aspartic acid, glutamine, glycine, valine, and phenylalanine or a salt thereof.

In one embodiment, the amino acid or salt thereof may be,
any one amino acid or a salt thereof selected from the group consisting of tryptophan, glutamic acid, histidine, alanine, arginine, aspartic acid, glutamine, glycine, valine, and phenylalanine or a salt thereof.

In one embodiment, the amino acid or salt thereof may be,
any one selected from the group consisting of tryptophan, histidine, alanine, arginine, aspartic acid, glutamine, glycine, valine and phenylalanine.

In one embodiment, the amino acid or salt thereof may be,
at least one (for example, one or more kinds, 2 or more kinds, 3 or more kinds, 4 or more kinds, 5 or more kinds, 6 or more kinds, 7 or more kinds, 8 or more kinds, 9 or more kinds, or 1 kind, 2 kinds, 3 kinds, 4 kinds, 5 kinds, 6 kinds, 7 kinds, 8 kinds, 9 kinds, or all of 10 kinds) amino acid selected from the group consisting of glutamic acid, histidine, tryptophan, arginine, glutamine, isoleucine, glycine, alanine, aspartic acid, and proline or a salt thereof.

In one embodiment, the amino acid or salt thereof may be,
a combination of at least one (for example, 1 kind or 2 kinds) amino acid selected from the group consisting of glutamic acid, and histidine or a salt thereof; and,
at least one (for example, one or more kinds, 2 or more kinds, 3 or more kinds, 4 or more kinds, 5 or more kinds, 6 or more kinds, 7 or more kinds, or 8 or more kinds, or 1 kind, 2 kinds, 3 kinds, 4 kinds, 5 kinds, 6 kinds, 7 kinds, or 8 kinds) amino acid selected from the group consisting of tryptophan, arginine, glutamine, isoleucine, glycine, alanine, aspartic acid, and proline or a salt thereof.

In one embodiment, the amino acid or salt thereof may be,
a combination of glutamic acid or a salt thereof, and histidine or a salt thereof; and
at least one (for example, one or more kinds, 2 or more kinds, 3 or more kinds, 4 or more kinds, 5 or more kinds, 6 or more kinds, or 7 or more kinds,, or 1 kind, 2 kinds, 3 kinds, 4 kinds, 5 kinds, 6 kinds, or 7 kinds) amino acid selected from the group consisting of tryptophan, arginine, glutamine, isoleucine, glycine, alanine, aspartic acid, and proline or a salt thereof.

In one embodiment, the amino acid or salt thereof may be,
a combination of glutamic acid and histidine; and,
at least one selected from the group consisting of tryptophan, arginine, glutamine, isoleucine, glycine, alanine, aspartic acid, and proline

In one embodiment, the amino acid or salt thereof may be,
1) a combination of glutamic acid or a salt thereof, histidine or a salt thereof, and tryptophan;
2) a combination of glutamic acid or a salt thereof, histidine or a salt thereof, arginine or a salt thereof, glutamine, and isoleucine;
3) a combination of glutamic acid or a salt thereof, histidine or a salt thereof, arginine or a salt thereof, and glycine; or
4) a combination of glutamic acid or a salt thereof, histidine or a salt thereof, arginine or a salt thereof, alanine, aspartic acid or a salt thereof, and glutamine; or
5) a combination of glutamic acid or a salt thereof, histidine or a salt thereof, tryptophan, and proline.

In one embodiment, the amino acid or salt thereof may be,
a combination of 1) glutamic acid, histidine and tryptophan;
2) glutamic acid, histidine, arginine, glutamine and isoleucine;
3) glutamic acid, histidine, arginine and glycine;
4) glutamic acid, histidine, arginine, alanine, aspartic acid and glutamine; or
5) glutamic acid, histidine, tryptophan and proline.

In one embodiment, the amino acid may be,
a combination of at least one (for example, one or more kinds, 2 or more kinds, 3 or more kinds, 4 or more kinds, 5 or more kinds, 6 or more kinds, 7 or more kinds, or 8 or more kinds, or 1 kind, 2 kinds, 3 kinds, 4 kinds, 5 kinds, 6 kinds, 7 kinds, or 8 kinds) amino acid selected from the group consisting of
histidine or a salt thereof of 1 part by weight; and
glutamic acid of 0.1 to 5 parts by weight, 0.1 to 4 parts by weight, 0.1 to 3 parts by weight, 0.1 to 2 parts by weight, 0.1 to 1.8 parts by weight, 0.1 to 1.695 parts by weight, 0.5 to 5 parts by weight, 0.5 to 4 parts by weight, 0.5 to 3 parts by weight, 0.5 to 2 parts by weight, 0.5 to 1.8 parts by weight, 0.5 to 1.695 parts by weight, 0.8 to 5 parts by weight, 0.8 to 4 parts by weight, 0.8 to 3 parts by weight, 0.8 to 2 parts by weight, 0.8 to 1.8 parts by weight, 0.8 to 1.695 parts by weight, 0.8 parts by weight, 1.333 parts by weight, 1.695 parts by weight, or 2 parts by weight,
tryptophan of 0.001 to 1 part by weight, 0.001 to 0.5 parts by weight, 0.001 to 0.1 part by weight, 0.001 to 0.085 parts by weight, 0.005 to 1 part by weight, 0.005 to 0.5 parts by weight, 0.005 to 0.1 part by weight, 0.005 to 0.085 parts by weight, 0.083 to 1 part by weight, 0.083 to 0.5 parts by weight, 0.083 to 0.1 part by weight, 0.083 to 0.085 parts by weight, 0.085 to 1 part by weight, 0.085 to 0.5 parts by weight, 0.085 to 0.1 part by weight, 0.083 parts by weight, or 0.085 parts by weight,
arginine of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight,
glutamine of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight,
isoleucine of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight,
glycine of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight,
alanine of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight,
aspartic acid of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight, and
proline of 0.05 to 1 part by weight, 0.05 to 0.833 parts by weight, 0.05 to 0.8 parts by weight, 0.05 to 0.6 parts by weight, 0.05 to 0.5 parts by weight, 0.05 to 0.4 parts by weight, 0.1 to 1 part by weight, 0.1 to 0.833 parts by weight, 0.1 to 0.8 parts by weight, 0.1 to 0.6 parts by weight, 0.1 to 0.5 parts by weight, 0.1 to 0.4 parts by weight, 0.167 to 1 part by weight, 0.167 to 0.833 parts by weight, 0.167 to 0.8 parts by weight, 0.167 to 0.6 parts by weight, 0.167 to 0.5 parts by weight, 0.167 to 0.4 parts by weight, 0.333 to 1 part by weight, 0.333 to 0.833 parts by weight, 0.333 to 0.8 parts by weight, 0.333 to 0.6 parts by weight, 0.333 to 0.5 parts by weight, 0.333 to 0.4 parts by weight, 0.4 to 1 part by weight, 0.4 to 0.833 parts by weight, 0.4 to 0.8 parts by weight, 0.4 to 0.6 parts by weight, 0.4 to 0.5 parts by weight, 0.667 to 1 part by weight, 0.667 to 0.833 parts by weight, 0.667 to 0.8 parts by weight, 0.8 to 1 part by weight, 0.8 to 0.833 parts by weight, 0.833 to 1 part by weight, 0.167 parts by weight, 0.333 parts by weight, 0.4 parts by weight, 0.667 parts by weight, 0.8 parts by weight, 0.833 parts by weight, or 1 part by weight,
based on 1 part by weight or histidine or a salt thereof, or a salt thereof.

In one embodiment, the amino acid or salt thereof may be
a combination of glutamic acid of 0.1 to 5 parts by weight,
tryptophan of 0.001 to 1 part by weight,
arginine of 0.05 to 1 part by weight,
glutamine of 0.05 to 1 part by weight,
isoleucine of 0.05 to 1 part by weight,
glycine of 0.05 to 1 part by weight,
alanine of 0.05 to 1 part by weight,
aspartic acid of 0.05 to 1 part by weight, or
proline of 0.05 to 1 part by weight,
based on histidine of 1 part by weight.

In one embodiment, the amino acid or salt thereof may be
a combination of (a) histidine 1 part by weight;
(b) glutamic acid 0.1 to 5 parts by weight; and
(c) at least one (for example, 1 kind, 2 kinds, 3 kinds, 4 kinds, 5 kinds, 6 kinds, 7 kinds, or 8 kinds) amino acid selected from the group consisting of tryptophan of 0.001 to 1 part by weight,
arginine of 0.05 to 1 part by weight,
glutamine of 0.05 to 1 part by weight,
isoleucine of 0.05 to 1 part by weight,
glycine of 0.05 to 1 part by weight,
alanine of 0.05 to 1 part by weight,
aspartic acid of 0.05 to 1 part by weight, and
proline of 0.05 to 1 part by weight,
based on histidine of 1 part by weight, or a salt thereof.

In one embodiment, the amino acid or salt thereof may be,
a combination of 1) glutamic acid of 0.1 to 5 parts by weight, histidine and tryptophan of 0.001 to 1 part by weight;
2) glutamic acid of 0.1 to 5 parts by weight, histidine, arginine of 0.05 to 1 part by weight, glutamine of 0.05 to 1 part by weight and isoleucine of 0.05 to 1 part by weight;
3) glutamic acid of 0.1 to 5 parts by weight, histidine, arginine of 0.05 to 1 part by weight and glycine of 0.05 to 1 part by weight;
4) glutamic acid of 0.1 to 5 parts by weight, histidine, arginine of 0.05 to 1 part by weight, alanine of 0.05 to 1 part by weight, aspartic acid of 0.05 to 1 part by weight and glutamine of 0.05 to 1 part by weight; or
5) glutamic acid of 0.1 to 5 parts by weight, histidine, tryptophan of 0.001 to 1 part by weight and proline of 0.05 to 1 part by weight,
based on histidine of 1 part by weight.

When the amino acid is used in a form of a salt of the amino acid, the weight of the amino acid may be 10 to 95% (w/w), 10 to 90% (w/w), 10 to 85% (w/w), 10 to 80% (w/w), 10 to 75% (w/w), 10 to 70% (w/w), 10 to 65% (w/w), 10 to 60% (w/w), 10 to 55% (w/w), 10 to 50% (w/w), 10 to 40% (w/w), 10 to 30% (w/w), 10 to 20% (w/w), 80% (w/w), or 86% (w/w), based on the weight of the salt of the amino acid, but not limited thereto.

In one specific embodiment, the weight of glutamic acid may be 86% (w/w) based on the weight of a sodium salt of glutamic acid (sodium glutamate).

In one specific embodiment, the weight of histidine may be 80% (w/w) based on the weight of hydrochloride of histidine.

### Composition and Method

One aspect provides a composition for alleviating drought stress (or, composition for enhancing drought stress resistance) comprising the amino acids or salt thereof as an active ingredient, by confirming that the amino acids or salt thereof has efficacy to alleviate drought stress of plants (or enhance drought stress resistance), and/or to promote plant growth.

Another aspect provides a use for alleviating drought stress (or, enhancing drought stress resistance) of the amino acid or salt thereof.

Other aspect provides a use for in the preparation of a composition for alleviating drought stress (or, composition for enhancing drought stress resistance) of the amino acid or salt thereof.

In the present description, the term “drought stress” means a condition in which normal water supply necessary for plant growth is not achieved or a condition in which sufficient amount of water required for plant growth is not provided due to irrigation facilities, environmental changes, and the like, and includes abiotic conditions showing damage to plant growth and survival (for example, exposure to dry conditions, exposure to water deficiency conditions). The drought stress may be induced by a compound (for example, PEG (polyethylene glycol)), or may be induced by suppling water of 90% or less, 80% or less, 70% or less, 60% or less, 50% or less, 40% or less, 30% or less, 20% or less, or 10% or less of common water required for normal growth of plants. In one specific embodiment, the drought stress may be induced by supplying 50% water of the normally supplied irrigation water.

Other aspect provides a composition for promoting plant growth comprising the amino acids as an active ingredient.

Other aspect provides a use for using in promoting plant growth of the amino acids or salt thereof.

Other aspect provides a use for preparation of a composition for promoting plant growth of the amino acids or salt thereof.

The composition for promoting plant growth by the present invention may be prepared by a common method, and specifically, it may be prepared in a dried powder form or a liquid fertilizer form. The composition for promoting plant growth of the present invention may replace chemical fertilizer, and may be usefully used for environmentally-friendly organic agriculture.

The composition for promoting plant growth may be used by applying to soil in a solid state, spraying in a liquid state around the plant and, immersing, spraying, on or coating on seeds, but not limited thereto.

Other aspect provides a fertilizer composition comprising the amino acids.

In the present description, the term “fertilizer” may mean a substance that causes chemical changes in soil to help plant cultivation, a substance that nutritional supplements for plants, and the like. The fertilizer may comprise at least one (for example, one or more kinds, 2 or more kinds, 3 or more kinds, or one kind, 2 kinds, 3 kinds or 4 kinds) selected from the group consisting of nitrogen, phosphorus, potassium and calcium, but not limited thereto. The fertilizer may be classified into organic fertilizers or inorganic fertilizers. The organic fertilizer may be plant-based fertilizer or animal-based fertilizer. The plant-based fertilizer may be compost, manure, oil cake such as sesame cake, rice bran, humus and the like, and the animal-based fertilizer may be silkworm pupa meal, bone meal, meat meal, carcass, excreta and the like. The inorganic fertilizer may be a single-component fertilizer or a compound fertilizer. The single-component fertilizer may include nitrogenous fertilizers (including urea, ammonium sulfate, ammonium nitrate, ammonium chloride and/or lime nitrogen, etc.), phosphoric fertilizers (including superphosphate lime (single superphosphate), polysuperphosphate lime (triple superphosphate), fused phosphate, and/or fused superphosphate, etc.), potassium fertilizers (including potassium chloride and/or potassium sulfate, etc.), calcareous (calcium) fertilizers (including lime, slacked lime and/or carbonated lime, etc.), siliceous fertilizers (including calcium silicate, etc.) and the like. The compound fertilizer may be fertilizer comprising at least two or more components selected from the group consisting of nitrogen, phosphorus, potassium, silicic acid and the like.

The fertilizer may further comprise an inorganic element such as sulfur, calcium, magnesia, boron, copper, zinc, manganese, iron, molybdenum, and the like.

The fertilizer may be formulated and used in various formulations such as a powder formulation, a granular formulation and the like. In the formulation, known additives, carriers and the like may be used.

Other aspect provides a method for plant cultivation, treating the amino acids or salt thereof, or the composition (composition for alleviating drought stress, composition for enhancing drought stress resistance, composition for promoting plant growth, or fertilizer composition). The method may be characterized by alleviating drought stress or enhancing drought stress resistance in plants

Other aspect provides a method for alleviating drought stress in plants, or a method for enhancing drought stress resistance in plants, comprising treating the amino acid or salt thereof, or the composition (composition for alleviating drought stress, composition for enhancing drought stress resistance, composition for promoting plant growth, or fertilizer composition) in plants.

The treatment method of the composition may be applied to the surface of the soil around the plants, or may be mixed or drench treated in the soil, and may be used by directly spraying or scattering it on the stem, leaf or branch of the plants, or spraying or immersing it in the seeds of the plants, but not limited thereto.

The amino acid and composition are as described above.

In one embodiment, the composition may comprise,
any one amino acid selected from the group consisting of tryptophan, histidine, alanine, arginine, aspartic acid, glutamine, glycine, valine and phenylalanine or a salt thereof.

In one embodiment, the composition may comprise,
glutamic acid and histidine; and,
at least one amino acid selected from the group consisting of tryptophan, arginine, glutamine, isoleucine, glycine, alanine, aspartic acid, and proline.

In one embodiment, the composition may comprise,
an amino acid combination of 1) glutamic acid, histidine and tryptophan;
2) glutamic acid, histidine, arginine, glutamine and isoleucine;
3) glutamic acid, histidine, arginine and glycine;
4) glutamic acid, histidine, arginine, alanine, aspartic acid and glutamine; or
5) glutamic acid, histidine, tryptophan and proline.

In one embodiment, the composition may comprise,
1) glutamic acid of 0.1 to 5 parts by weight, histidine and tryptophan of 0.001 to 1 part by weight;
2) glutamic acid of 0.1 to 5 parts by weight, histidine, arginine of 0.05 to 1 part by weight, glutamine of 0.05 to 1 part by weight and isoleucine of 0.05 to 1 part by weight;
3) glutamic acid of 0.1 to 5 parts by weight, histidine, arginine of 0.05 to 1 part by weight and glycine of 0.05 to 1 part by weight;
4) glutamic acid of 0.1 to 5 parts by weight, histidine, arginine of 0.05 to 1 part by weight, alanine of 0.05 to 1 part by weight, aspartic acid of 0.05 to 1 part by weight and glutamine of 0.05 to 1 part by weight; or
5) glutamic acid of 0.1 to 5 parts by weight, histidine, tryptophan of 0.001 to 1 part by weight and proline of 0.05 to 1 part by weight,
based on histidine of 1 part by weight.

When the amino acid or salt thereof is used as comprised alone in the composition (composition for alleviating drought stress, fertilizer composition or composition for promoting plant growth) provided in the present description and used, the concentration of the amino acid in the composition may be 0.001 to 10% (w/w), 0.001 to 5% (w/w), 0.001 to 2.5% (w/w), 0.001 to 1% (w/w), 0.001 to 0.5% (w/w), 0.001 to 0.1% (w/w), 0.005 to 10% (w/w), 0.005 to 5% (w/w), 0.005 to 2.5% (w/w), 0.005 to 1% (w/w), 0.005 to 0.5% (w/w), 0.005 to 0.1% (w/w), 0.01 to 10% (w/w), 0.01 to 5% (w/w), 0.01 to 2.5% (w/w), 0.01 to 1% (w/w), 0.01 to 0.5% (w/w), 0.01 to 0.1% (w/w), 0.05 to 10% (w/w), 0.05 to 5% (w/w), 0.05 to 2.5% (w/w), 0.05 to 1% (w/w), 0.05 to 0.5% (w/w), 0.05 to 0.1% (w/w), 0.05 (w/w), or 0.1% (w/w), based on the weight of the amino acid compared to the weight of the composition. In one embodiment, the composition may be an amino acid aqueous solution.

When at least 2 kinds of amino acids or salts thereof are used in combination in the composition (composition for alleviating drought stress, fertilizer composition or composition for promoting plant growth) provided in the present description, the concentration of the amino acids or salt thereof in the composition may be 10 to 50% (w/w), 10 to 45% (w/w), 10 to 40% (w/w), 10 to 35% (w/w), 10 to 30% (w/w), 10 to 25% (w/w), 12.5 to 50% (w/w), 12.5 to 45% (w/w), 12.5 to 40% (w/w), 12.5 to 35% (w/w), 12.5 to 30% (w/w), 12.5 to 25% (w/w), 15 to 50% (w/w), 15 to 45% (w/w), 15 to 40% (w/w), 15 to 35% (w/w), 15 to 30% (w/w), 15 to 25% (w/w), 16.4% (w/w), 22% (w/w), 23% (w/w), or 23.5% (w/w), based on the weight of the amino acid compared to the weight of the composition.

In the composition (composition for alleviating drought stress, composition for promoting plant growth, or fertilizer composition) and/or method provided in the present description, the composition to be applied to plants may be used as appropriately diluted, and for example, it may be used as diluted by 1 to 10000 times, 1 to 7500 times, 1 to 5000 times, 1 to 2500 times, 1 to 1000 times, 1 to 900 times, 1 to 800 times, 1 to 700 times, 1 to 600 times, 1 to 500 times, 1 to 400 times, 1 to 300 times, 1 to 200 times, 1 to 100 times, 10 to 10000 times, 10 to 7500 times, 10 to 5000 times, 10 to 2500 times, 10 to 1000 times, 10 to 900 times, 10 to 800 times, 10 to 700 times, 10 to 600 times, 10 to 500 times, 10 to 400 times, 10 to 300 times, 10 to 200 times, 10 to 100 times, 50 to 10000 times, 50 to 7500 times, 50 to 5000 times, 50 to 2500 times, 50 to 1000 times, 50 to 900 times, 50 to 800 times, 50 to 700 times, 50 to 600 times, 50 to 500 times, 50 to 400 times, 50 to 300 times, 50 to 200 times, 50 to 100 times, 100 to 10000 times, 100 to 7500 times, 100 to 5000 times, 100 to 2500 times, 100 to 1000 times, 100 to 900 times, 100 to 800 times, 100 to 700 times, 100 to 600 times, 100 to 500 times, 100 to 400 times, 100 to 300 times, or 100 to 200 times. In one specific embodiment, the composition may be used as diluted by 500 times. The composition may be diluted with water and the like, but not limited thereto.

In the composition (composition for alleviating drought stress, composition for promoting plant growth, or fertilizer composition) and/or method provided in the present description, when the composition is used as diluted, it may be used as diluted so that the concentration (% (w/w)) of the amino acid comprised in the composition is to be 0.01 to 10% (w/w), 0.01 to 5% (w/w), 0.01 to 4% (w/w), 0.01 to 3% (w/w), 0.01 to 2% (w/w), 0.01 to 1% (w/w), 0.01 to 0.9% (w/w), 0.01 to 0.8% (w/w), 0.01 to 0.7% (w/w), 0.01 to 0.6% (w/w), 0.01 to 0.5% (w/w), 0.01 to 0.4% (w/w), 0.01 to 0.3% (w/w), 0.01 to 0.2% (w/w), 0.01 to 0.1% (w/w), 0.01 to 0.05% (w/w), 0.05 to 10% (w/w), 0.05 to 5% (w/w), 0.05 to 4% (w/w), 0.05 to 3% (w/w), 0.05 to 2% (w/w), 0.05 to 1% (w/w), 0.05 to 0.9% (w/w), 0.05 to 0.8% (w/w), 0.05 to 0.7% (w/w), 0.05 to 0.6% (w/w), 0.05 to 0.5% (w/w), 0.05 to 0.4% (w/w), 0.05 to 0.3% (w/w), 0.05 to 0.2% (w/w), 0.05 to 0.1% (w/w), 0.1 to 10% (w/w), 0.1 to 5% (w/w), 0.1 to 4% (w/w), 0.1 to 3% (w/w), 0.1 to 2% (w/w), 0.1 to 1% (w/w), 0.1 to 0.9% (w/w), 0.1 to 0.8% (w/w), 0.1 to 0.7% (w/w), 0.1 to 0.6% (w/w), 0.1 to 0.5% (w/w), 0.1 to 0.4% (w/w), 0.1 to 0.3% (w/w), 0.1 to 0.2% (w/w), 0.2 to 10% (w/w), 0.2 to 5% (w/w), 0.2 to 4% (w/w), 0.2 to 3% (w/w), 0.2 to 2% (w/w), 0.2 to 1% (w/w), 0.2 to 0.9% (w/w), 0.2 to 0.8% (w/w), 0.2 to 0.7% (w/w), 0.2 to 0.6% (w/w), 0.2 to 0.5% (w/w), 0.2 to 0.4% (w/w), 0.2 to 0.3% (w/w), 0.3 to 10% (w/w), 0.3 to 5% (w/w), 0.3 to 4% (w/w), 0.3 to 3% (w/w), 0.3 to 2% (w/w), 0.3 to 1% (w/w), 0.3 to 0.9% (w/w), 0.3 to 0.8% (w/w), 0.3 to 0.7% (w/w), 0.3 to 0.6% (w/w), 0.3 to 0.5% (w/w), 0.3 to 0.4% (w/w), 0.4 to 10% (w/w), 0.4 to 5% (w/w), 0.4 to 4% (w/w), 0.4 to 3% (w/w), 0.4 to 2% (w/w), 0.4 to 1% (w/w), 0.4 to 0.9% (w/w), 0.4 to 0.8% (w/w), 0.4 to 0.7% (w/w), 0.4 to 0.6% (w/w), 0.4 to 0.5% (w/w), 0.5 to 10% (w/w), 0.5 to 5% (w/w), 0.5 to 4% (w/w), 0.5 to 3% (w/w), 0.5 to 2% (w/w), 0.5 to 1% (w/w), 0.5 to 0.9% (w/w), 0.5 to 0.8% (w/w), 0.5 to 0.7% (w/w), 0.5 to 0.6% (w/w), 0.8 to 10% (w/w), 0.8 to 5% (w/w), 0.8 to 4% (w/w), 0.8 to 3% (w/w), 0.8 to 2% (w/w), 0.8 to 1% (w/w), or 0.8 to 0.9% (w/w), but not limited thereto.

Plants applicable to the amino acid, composition (composition for alleviating drought stress, composition for promoting plant growth, or fertilizer composition) and/or method provided in the present description is not particularly limited, and for example, it may be applicable to plants of family Fabaceae (for example, plant of genus Phaseolus (for example, Phaseolus vulgaris, Phaseolus lunatus, Phaseolus coccineus etc), plant of genus Glycine (for example, bean (or soybean, Glycine max), Glycine soja etc), plant of genus Pisum (for example, Pisum sativum etc), plant of genus Arachis (for example, peanut (Arachis hypogaea) etc), plant of genus Euchresta (for example, Euchresta japonica Hook. f. ex Regel etc), plant of genus Rhynchosia (for example, Rhynchosia volubilis Lour, Rhynchosia acuminatifolia Makino etc), plant of genus Lens (for example, lentil bean (or Lens culinaris) etc),
or plant of family Brassicaceae (for example, plant of genus Arabidopsis (for example, Arabidopsis thaliana), plant of genus Brassica (for example, Brassica carinata, Brassica juncea var. juncea, Brassica rapa, Brassica rapa sub sp. chinensis, Brassica rapa subsp. pekinensis, Brassica napus, Brassica campestris L., Brassica nigra, Brassica oleracea (including collard, gairan, cauliflower, cabbage, Brussels sprout, kohlrabi, broccoli, savoy cabbage, ornamental cabbage, kale, etc.)), plant of genus Raphanus (for example, Raphanus raphanistrum, Raphanus raphanistrum subsp. sativus etc) or the like, but not limited thereto.

The part of a plant applicable to the composition (composition for alleviating drought stress, composition for promoting plant growth, or fertilizer composition) and/or method provided in the present description is not particularly limited, and for example, it may be at least one selected from the group consisting of-whole plants, seeds, roots, leaves (for example, upper surface of a leaf and/or lower surface of a leaf, foliar fertilization or foliar spray), a stem, a flower, and the like.

In one embodiment, the amount of the composition (composition for alleviating drought stress, composition for promoting plant growth, or fertilizer composition) to be applied to plants may be treated in a capacity of about 1 to 1000 ml, 1 to 900 ml, 1 to 800 ml, 1 to 700 ml, 1 to 600 ml, 1 to 500 ml, 1 to 400 ml, 1 to 300 ml, 1 to 200 ml, 1 to 100 ml, 1 to 90 ml, 1 to 80 ml, 1 to 70 ml, 1 to 60 ml, 1 to 50 ml, 1 to 40 ml, 1 to 35 ml, 1 to 30 ml, 1 to 20 ml, 1 to 10 ml, 5 to 1000 ml, 5 to 900 ml, 5 to 800 ml, 5 to 700 ml, 5 to 600 ml, 5 to 500 ml, 5 to 400 ml, 5 to 300 ml, 5 to 200 ml, 5 to 100 ml, 5 to 90 ml, 5 to 80 ml, 5 to 70 ml, 5 to 60 ml, 5 to 50 ml, 5 to 40 ml, 5 to 35 ml, 5 to 30 ml, 5 to 20 ml, 5 to 10 ml, 10 to 1000 ml, 10 to 900 ml, 10 to 800 ml, 10 to 700 ml, 10 to 600 ml, 10 to 500 ml, 10 to 400 ml, 10 to 300 ml, 10 to 200 ml, 10 to 100 ml, 10 to 90 ml, 10 to 80 ml, 10 to 70 ml, 10 to 60 ml, 10 to 50 ml, 10 to 40 ml, 10 to 35 ml, 10 to 30 ml, 10 to 20 ml, 50 to 1000 ml, 50 to 900 ml, 50 to 800 ml, 50 to 700 ml, 50 to 600 ml, 50 to 500 ml, 50 to 400 ml, 50 to 300 ml, 50 to 200 ml, 50 to 100 ml, 50 to 90 ml, 50 to 80 ml, 50 to 70 ml, 50 to 60 ml, 50 to 1000 ml, 50 to 900 ml, 50 to 800 ml, 50 to 700 ml, 50 to 600 ml, 50 to 500 ml, 50 to 400 ml, 50 to 300 ml, 50 to 200 ml, 50 to 100 ml, 50 to 90 ml, 50 to 80 ml, 50 to 70 ml, 50 to 60 ml, 100 to 1000 ml, 100 to 900 ml, 100 to 800 ml, 100 to 700 ml, 100 to 600 ml, 100 to 500 ml, 100 to 400 ml, 100 to 300 ml, 100 to 200 ml, 200 to 1000 ml, 200 to 900 ml, 200 to 800 ml, 200 to 700 ml, 200 to 600 ml, 200 to 500 ml, 200 to 400 ml, or 200 to 300 ml once, but not limited thereto.

The composition (composition for alleviating drought stress, composition for promoting plant growth, or fertilizer composition) may be treated to plants once to 20 times, once to 15 times, once to 10 times, once to 9 times, once to 8 times, once to 7 times, once to 6 times, once to 5 times, once to 4 times, or once to 3 times, in total, and may be treated at an interval of one day, at an interval of 2 days, at an interval of 3 days, at an interval of 5 days, at an interval of 7 days (or 1 week), at an interval of 10 days, at an interval of 14 days (or 2 weeks), at an interval of 15 days, at an interval of 20 days, at an interval of 21 days (or 3 weeks), at an interval of 25 days, at an interval of 28 days (or 4 weeks), at an interval of 30 days (or 1 month), at an interval of 45 days, or at an interval of 60 days (or 2 months), but not limited thereto.

### Advantageous Effects

By treating the composition comprising amino acids of the present application in plants, an excellent effect of alleviating drought stress of a plant, and/or promoting plant growth was confirmed.

### BRIEF DESCRIPTION OF THE DRAWINGS

FIG. 1 shows photographs of the above-ground and below-ground tissues of Arabidopsis thaliana which were grown under drought stress-induced media with treatment of water, commercial product, A.P (control), or 8 kinds of amino acids (His, MSG, Pro, Thr, Trp, Val), respectively.

FIG. 2 shows the fresh weight (mg) of aboveground tissues and root length (cm) of Arabidopsis thaliana which were grown under the drought stress-induced media with treatment of water, commercial product, A.P (control) or 8 kinds of amino acids, as graphs.

FIG. 3 shows photographs of the above-ground and below-ground tissues of Arabidopsis thaliana which were grown under drought stress-induced media with treatment of water, commercial product, A.P (control), or 13 kinds of amino acids (Ala, Arg, Asn, Asp, Cys, Gln, Gly, Ile, Leu, Lys, Met, Phe, Ser, Tyr), respectively.

FIG. 4 shows the fresh weight (mg) of above-ground tissues and root length (cm) of Arabidopsis thaliana which were grown under drought stress-induced media with treatment of water, commercial product, A.P or 13 kinds of amino acids as graphs.

FIG. 5 shows the experimental schedule of inducing drought stress in soybeans and treating amino acid composition to determine alleviating drought stress of the present application.

FIG. 6 shows the number of pods and yield (productivity) of soybean which were grown under either normal water condition (100% irrigation) or the drought stress condition (50% irrigation) with treatment of control or amino acid compositions (CJ1 to cJ8). The value of pod numbers and yield were calculated by percentage compared to value of water treated plants which were grown under the drought stress condition.

### MODE FOR INVENTION

Hereinafter, the present invention will be described in more detail by the following examples. However, these are intended to illustrate the present invention only, but the scope of the present invention is not limited by these examples.

### EXAMPLE 1. SELECTION OF AMINO ACIDS WITH EFFICACY OF ALLEVIATING DROUGHT STRESS IN ARABIDOPSIS THALIANA (SINGLE AMINO ACID TREATMENT)

### Example 1-1. Experimental Method (Laboratory Condition, Plate Assay)

In order to select an individual amino acid having function in alleviating drought stress among 20 kinds of amino acids (histidine, sodium glutamate, proline, threonine, tryptophan, valine, alanine, arginine, asparagine, aspartic acid, cysteine, glutamine, glycine, leucine, lysine, methionine, phenylalanine, serine, or tyrosine), Arabidopsis thaliana was trans-planted in drought stress-induced medium, and an amino acid aqueous solution comprising each amino acid (0.05% (w/w) or 0.1% (w/w)) was treated, then the fresh weight of the above-ground tissue and growth and development of the root (main root) of Arabidopsis thaliana were investigated.

Arabidopsis thaliana seeds (provided by Konkuk University plant development genomics lab) were put in a 2% Sodium hypochlorite, 0.05% Tween 20 solution and sterilized for 1 minute, then washed with water 4 times. The sterilized seeds were incubated in dark and cold (4 degrees) for 3 days.

Arabidopsis thaliana seeds were sown in a plant growth medium (½ MS; Murashige and Skoog Medium, Duchefa Biochem), and grow for 6 days in the growth chamber. The growth condition of plants is as follows:
Temperature: 23° C.; humidity: 60˜65%; light: light 16 hours/dark 8 hours

The drought stress-induced medium was prepared by the method as below.

PEG (polyethylene glycol, Cas No. 25322-68-3) is known as a substance which induces drought stress by changing the osmotic pressure of plants., It means that plants are grown in a medium comprising PEG 6000 response similar to that of a plant subjected to drought stress appears, and representative phenotypic changes include a decrease in growth and development and reduction of productivity, and the like.

20 ml of 20% (w/w) PEG 6000 (Sigma Aldrich, Cas no. 25322-68-3) was applied on the ½ MS solid medium, and incubated under a sterile condition for 24 hours. After 24 hours, the PEG solution was removed and dried at a room temperature under a sterile condition.

6 days-old Arabidopsis thaliana seedlings grown in normal plant growth medium were transferred to the drought stress-induced medium (PEG 20% treated) or a control medium (PEG untreated).

Immediately after transfer seedlings on the drought-stress induced medium, an individual amino acid aqueous solution (0.05% (w/w) or 0.1% (w/w)) was sprayed on the plants; 1 ml/plate, 3 days intervals, for 4 times. As a control group, instead of the amino acid aqueous solution, water (DW, distilled water) or A company's drought stress-alleviating product (AP product, comprising Pro 9%, MSG 2.5%, Asp 0.9%) (Ajinomoto Fertilizers, Amino proline) was sprayed by the same method.

After that, the fresh weight, and root growth and development of Arabidopsis thaliana were investigated. Shown in Example 1-2 and Example 1-3 below.

### Example 1-2. Experimental Result of 6 Kinds of Amino Acids

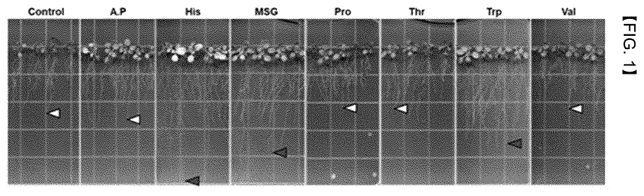

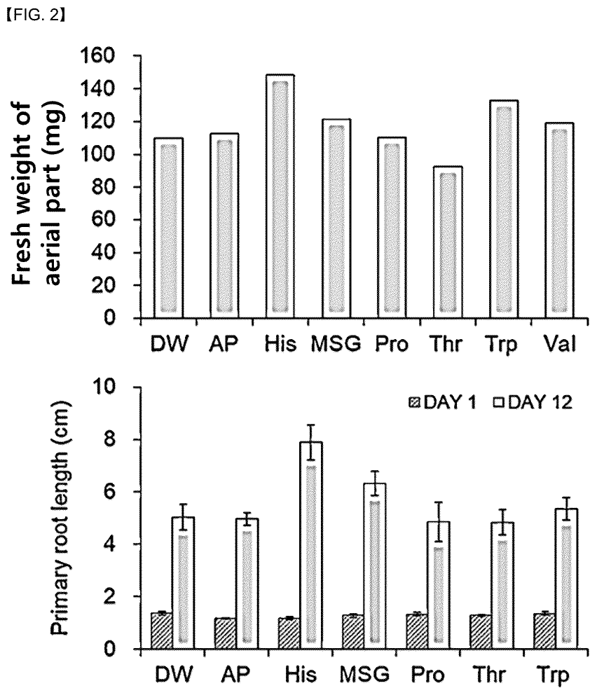

After spraying an aqueous solution of 6 kinds of amino acids (histidine (His), sodium glutamate (MSG), proline (Pro), threonine (Thr), tryptophan (Trp), or valine (Val)) to Arabidopsis thaliana grown in a drought stress-induced medium (PEG 20% treated), the growth of above-and below-ground tissues of Arabidopsis were investigated, and as the result, the overall photograph of Arabidopsis thaliana was shown in FIG. 1, and the fresh weight (mg) of above-ground tissues and the root length (cm) were shown in FIG. 2.

As could be confirmed in FIG. 1 and FIG. 2, the growth and development of above-and below-ground tissues of Arabidopsis thaliana were excellent in case of treating a tryptophan, sodium glutamate, histidine, or valine aqueous solution, compared to the case of treating water or A company's product (AP) (FIG. 1 and FIG. 2).

### Example 1-3. Experimental Result of 14 Kinds of Amino Acids

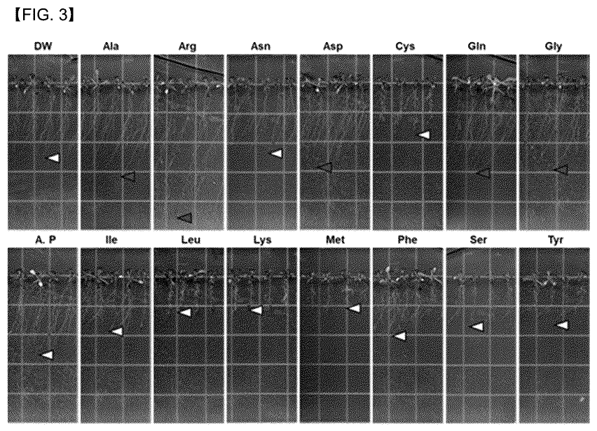

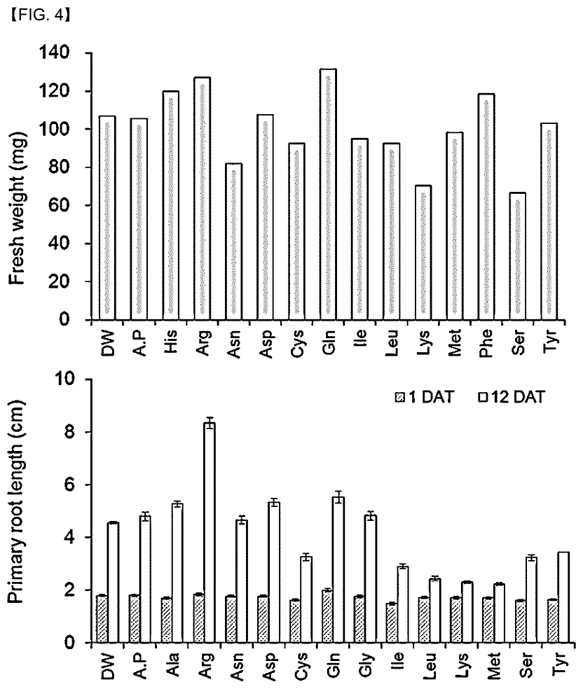

After spraying an aqueous solution of the rest 14 kinds of amino acids (alanine (Ala), arginine (Arg), asparagine (Asn), aspartic acid (Asp), cysteine (Cys), glutamine (Gln), glycine (Gly), isoleucine (Ile), leucine (Leu), lysine (Lys), methionine (Met), phenylalanine (Phe), serine (Ser), or tyrosine (Tyr)), in addition to the 6 kinds of amino acids of which effect was confirmed in Example 1-2, the growth of above-and below-ground tissues of Arabidopsis were investigated, as the result, the overall photograph of Arabidopsis thaliana was shown in FIG. 3 and the fresh weight (mg) of above-ground tissues and root length (cm) were shown in FIG. 4.

As could be confirmed in FIG. 3 and FIG. 4, the growth and development of above-and below-ground tissues of Arabidopsis thaliana were excellent in case of treating an alanine, arginine, aspartic acid, glutamine, glycine or phenylalanine aqueous solution, compared to the case of treating water or A company's product (AP) (FIG. 3 and FIG. 4).

From the result of Example 1-2 and Example 1-3 above, it was confirmed that 9 amino acids, tryptophan, sodium glutamate, histidine, alanine, arginine, aspartic acid, glutamine, phenylalanine, or glycine have positive function in alleviating drought stress and promoting plant growth under laboratory condition (plate assay).

### EXAMPLE 2. DROUGHT STRESS ALLEVIATING EFFICACY AMINO ACID COMBINATION RECIPE DESIGN

Including the amino acids having functions in alleviating drought stress selected with Arabidopsis thaliana in Example 1, recipes of combination/mixing of various amino acids were designed, and 8 specific recipes was selected by simple test with Arabidopsis thaliana.

The 8 recipes of amino acid combination are as Table 1 below. In CJ1 to CJ8, the rest components other than amino acids were used by adding water and the content of amino acids expressed as the weight of amino acids relative to the weight of the total composition (% (w/w)).

TABLE 1

| | | |
|---|---|---|
| 100% | Conven- | Water |
| Irrigation | tional | |
| Drought | Water | Water |
| stress | A product | A company A product (Pro 9%, MSG 2.5%, |
| (50% | | ASP 0.9%) |
| irrigation) | CJ1 | 10% MSG, 5.0% His-HCl, 0.5% Trp |
| | CJ2 | 10% MSG, 8% His-HCl, 5% Arg |
| | CJ3 | 8% MSG, 6% His-HCl, 5% Arg, 2% Gln, 1% Ile |
| | CJ4 | 8% MSG, 6% His-HCl, 4% Arg, 5% Gly |
| | CJ5 | 8% MSG, 5% His-HCl, 5% Arg, 5% Ala |
| | CJ6 | 4% MSG, 5% His-HCl, 5% Arg, 4% Ala, |
| | | 2% Asp, 2% Gln |
| | CJ7 | 12% MSG, 6% His-HCl, 5% Gly, 0.5% Trp |
| | CJ8 | 12% MSG, 6% His-HCl, 0.5% Trp, 5% Pro |

### EXAMPLE 3. VERIFICATION OF EFFICACY OF AMINO ACID RECIPES (COMBINATIONS) FOR DROUGHT STRESS ALLEVIATING OF SOYBEANS (TREATMENT OF AMINO ACID COMBINATIONS)

### Example 3-1. Experimental Method (Greenhouse Condition, Pot)

In order to select a recipe with excellent drought stress alleviating efficacy, the composition according to each amino acid combination (CJ1 to CJ8) was treated in drought stress-induced soybeans, and then the number of pods and the final yield (productivity, weight of harvested beans) of soybean were investigated.

Soybean seeds (domestic soybean seeds purchased online) were sown in a glass greenhouse in May. The life cycle of soybean from seeds to seeds takes around 5-6 months; start flowering at June, pod formation at July, develop seeds at August-September, and final harvest in October. The control group in which drought stress was not induced was grown by irrigation of an appropriate amount of water through conventional farming (100% irrigation, no stress treatment).

In case of the soybeans in which drought stress was induced, irrigation was normally performed until V5 (nutritive growth period, 45 days after sowing) after sowing, and drought stress was induced with 50% irrigation from the initial flowering period (50 days after sowing) to the pod formation period (90 days after sowing).

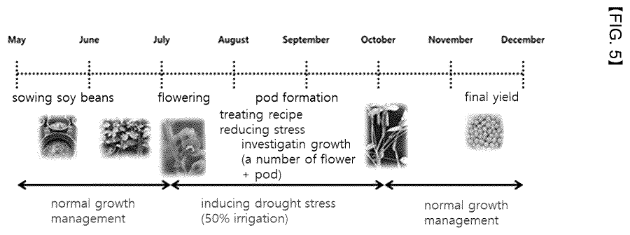

The drought stress alleviating effect was confirmed by treating the composition according to the drought stress alleviating amino acid combination recipe shown in Table 1. Amino acid combination recipes were treated 3 times in total. The first treatment was performed one week after inducing drought stress, and following treatments were performed at 7 to 10 days intervals. As a control group, water (DW) or A company's drought stress alleviating product (AP product, comprising Pro 9%, MSG 2.5%, Asp 0.9%) was treated with the same method. The composition according to the amino acid recipe was diluted 500-fold and treated in an amount of 5 to 100 ml (treated in an amount of 1 to 20 L of the stock solution per 1 hectare (ha)). The entire experimental process was shown in FIG. 5 as a picture.

Then, the number of the pods and the yield (productivity, weight of harvested beans) of soybean were investigated, shown in Example 3-2 below.

### Example 3-2. Experimental Results of Amino Acid Combination Recipes

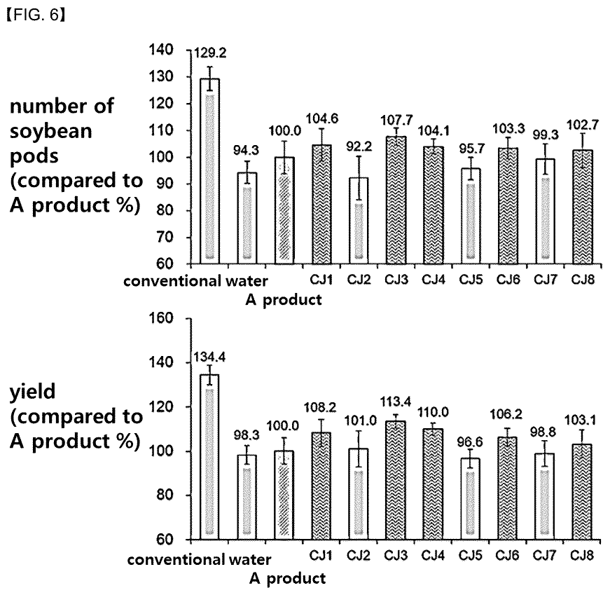

After treating the 8 recipes of amino acid combinations (CJ1 to CJ8) in the drought stress-induced soybeans, the number of the pods and the yield of soybean were investigated, shown in FIG. 6. In FIG. 6, the value of pod numbers and yield were calculated by percentage compared to value of A company's product treated plants which were grown under the drought stress condition; “Conventional” is a group in which soybeans are grown normally without drought stress; “water” is a control group in which water is treated in the drought stress-induced soybeans; CJ1 to CJ8 are the results of the experimental groups in which the compositions according to the amino acid combination recipes of Table 1 above are treated in the drought stress-induced soybeans.

As shown in FIG. 6, the drought stress treated plants, the group in which water was treated to the drought stress-induced soybean, showed that the number of soybean pods and bean yield decreased by about 30% compared to the “conventional” treatment group (100% irrigation, no stress treatment control group).

When the compositions according to the amino acid combination recipes of Table 1 (CJ1, CJ3, CJ4, CJ6, and CJ8) were treated to the drought stress-induced soybeans, the drought stress-induced phenomenon which is decreased the number of pods and yield of soybean was recovered. It means that these compositions have the efficacy of alleviating drought stress.

The amino acid content of the composition CJ1 to CJ8 is similar as about 15 to 20%, but as shown in FIG. 7, the efficacy of alleviating drought stress is dependent on the combination of amino acids. It means that combination of amino acids is more important than total content of amino acids for the efficacy of the amino acid based product. This result shows the synergistic/antagonistic effect among amino acids, and suggests that the different combinations of amino acids may significantly effect on the efficacy of alleviating drought stress in plants.

From the above description, those skilled in the art which the present invention pertains will understand that the present invention may be conducted in other specific forms without changing the technical spirit or essential characteristics thereof. In this regard, it should be understood that the examples described above are illustrative and not restrictive in all respects. The scope of the present invention should be construed as all changed or modified forms derived from the meaning and scope of the present invention and equivalents thereof rather than the above detailed description are included in the scope of the present invention.

1-19. (canceled)

20. A method for alleviating drought stress in a subject in need thereof, comprising administering
(a) a composition comprising any one amino acid or a salt thereof selected from the group consisting of tryptophan, histidine, alanine, arginine, aspartic acid, glutamine, glycine, valine and phenylalanine or a salt thereof to the subject; or
(b) a composition comprising a combination of the following amino acids or salts thereof:
(1) glutamic acid and histidine; and
(2) at least one amino acid selected from the group consisting of tryptophan, arginine, glutamine, isoleucine, glycine, alanine, aspartic acid, and proline, to the subject.

21. The method according to claim 20, wherein a concentration of the amino acid in the composition (a) administered to the subject is 0.01 to 10% (w/w).

22. The method according to claim 20, wherein the combination of the amino acids in the composition (b) administered to the subject is
1) glutamic acid, histidine and tryptophan;
2) glutamic acid, histidine, arginine, glutamine and isoleucine;
3) glutamic acid, histidine, arginine and glycine;
4) glutamic acid, histidine, arginine, alanine, aspartic acid and glutamine; or
5) glutamic acid, histidine, tryptophan and proline.

23. The method according to claim 20, wherein the composition (b) administered to the subject comprises
glutamic acid of 0.1 to 5 parts by weight,
tryptophan of 0.001 to 1 part by weight,
arginine of 0.05 to 1 part by weight,
glutamine of 0.05 to 1 part by weight,
isoleucine of 0.05 to 1 part by weight,
glycine of 0.05 to 1 part by weight,
alanine of 0.05 to 1 part by weight,
aspartic acid of 0.05 to 1 part by weight, or
proline of 0.05 to 1 part by weight,
based on histidine of 1 part by weight.

24. The method according to claim 20, wherein a concentration of the amino acid in the composition (b) administered to the subject is 10 to 50% (w/w).

25. The method according to claim 20, wherein the subject is any one plant selected from the group consisting of plant of genus Phaseolus, plant of genus Glycine, plant of genus Pisum, plant of genus Arachis, plant of genus Euchresta, plant of genus Rhynchosia, plant of genus Lens, plant of genus Arabidopsis, plant of genus Brassica and plant of genus Raphanus.

26. A method for promoting plant growth in a subject in need thereof, comprising administering
(a) a composition comprising any one amino acid or a salt thereof selected from the group consisting of tryptophan, histidine, alanine, arginine, aspartic acid, glutamine, glycine, valine and phenylalanine or a salt thereof to the subject; or
(b) a composition comprising a combination of the following amino acids or salts thereof:
(1) glutamic acid and histidine; and,
(2) at least one amino acid selected from the group consisting of tryptophan, arginine, glutamine, isoleucine, glycine, alanine, aspartic acid, and proline, to the subject.

27. The method according to claim 26, wherein a concentration of the amino acid in the composition (a) administered to the subject is 0.01 to 10% (w/w).

28. The method according to claim 26, wherein the combination of the amino acids in the composition (b) administered to the subject is
1) glutamic acid, histidine and tryptophan;
2) glutamic acid, histidine, arginine, glutamine and isoleucine;
3) glutamic acid, histidine, arginine and glycine;
4) glutamic acid, histidine, arginine, alanine, aspartic acid and glutamine; or
5) glutamic acid, histidine, tryptophan and proline.

29. The method according to claim 26, wherein the composition (b) administered to the subject comprises
glutamic acid of 0.1 to 5 parts by weight,
tryptophan of 0.001 to 1 part by weight,
arginine of 0.05 to 1 part by weight,
glutamine of 0.05 to 1 part by weight,
isoleucine of 0.05 to 1 part by weight,
glycine of 0.05 to 1 part by weight,
alanine of 0.05 to 1 part by weight,
aspartic acid of 0.05 to 1 part by weight, or
proline of 0.05 to 1 part by weight,
based on histidine of 1 part by weight.

30. The method according to claim 26, wherein a concentration of the amino acid in the composition (b) administered to the subject is 10 to 50% (w/w).

31. The method according to claim 26, wherein the subject is any one plant selected from the group consisting of plant of genus Phaseolus, plant of genus Glycine, plant of genus Pisum, plant of genus Arachis, plant of genus Euchresta, plant of genus Rhynchosia, plant of genus Lens, plant of genus Arabidopsis, plant of genus Brassica and plant of genus Raphanus.

32. The method according to claim 26, wherein the method alleviates drought stress of the plant.

33. A method for cultivating a plant, comprising administering
(a) a composition comprising any one amino acid or a salt thereof selected from the group consisting of tryptophan, histidine, alanine, arginine, aspartic acid, glutamine, glycine, valine and phenylalanine or a salt thereof to the plant; or
(b) a composition comprising a combination of the following amino acids or salts thereof:
(1) glutamic acid and histidine; and
(2) at least one amino acid selected from the group consisting of tryptophan, arginine, glutamine, isoleucine, glycine, alanine, aspartic acid, and proline, to the plant.

34. The method according to claim 33, wherein a concentration of the amino acid in the composition (a) administered to the subject is 0.01 to 10% (w/w).

35. The method according to claim 33, wherein a combination of the amino acids in the composition (b) administered to the subject is
1) glutamic acid, histidine and tryptophan; p1 2) glutamic acid, histidine, arginine, glutamine and isoleucine;
3) glutamic acid, histidine, arginine and glycine;
4) glutamic acid, histidine, arginine, alanine, aspartic acid and glutamine; or
5) glutamic acid, histidine, tryptophan and proline.

36. The method according to claim 33, wherein the composition (b) administered to the subject comprises
glutamic acid of 0.1 to 5 parts by weight,
tryptophan of 0.001 to 1 part by weight,
arginine of 0.05 to 1 part by weight,
glutamine of 0.05 to 1 part by weight,
isoleucine of 0.05 to 1 part by weight,
glycine of 0.05 to 1 part by weight,
alanine of 0.05 to 1 part by weight,
aspartic acid of 0.05 to 1 part by weight, or
proline of 0.05 to 1 part by weight,
based on histidine of 1 part by weight.

37. The method according to claim 33, wherein a concentration of the amino acid in the composition of claim 14 (b) administered to is 10 to 50% (w/w).

38. The method according to claim 33, wherein the subject is any one plant selected from the group consisting of plant of genus Phaseolus, plant of genus Glycine, plant of genus Pisum, plant of genus Arachis, plant of genus Euchresta, plant of genus Rhynchosia, plant of genus Lens, plant of genus Arabidopsis, plant of genus Brassica and plant of genus Raphanus.

39. The method according to claim 33, wherein the method alleviates drought stress of the plant.
